(19) United States
(12) Patent Application Publication
(10) Pub. No.: US 2019/0337705 A1
(43) Pub. Date: Nov. 7, 2019

(54) INSULATED COOLER FOR CANNED BEVERAGES

(71) Applicants: CRANFORD P. McGEE, MOORESVILLE, NC (US); DONGXIA ZHAO, SHENZHEN (CN)

(72) Inventors: CRANFORD P. McGEE, MOORESVILLE, NC (US); DONGXIA ZHAO, SHENZHEN (CN)

(73) Assignee: SOUTHERN SALES & MARKETING GROUP, INC., Titusville, NJ (US)

(21) Appl. No.: 16/178,921

(22) Filed: Nov. 2, 2018

Related U.S. Application Data
(63) Continuation of application No. PCT/US17/30699, filed on May 2, 2017.

(51) Int. Cl. B65D 81/38; B65D 83/00; A45F 3/02; A45C 11/20; A47J 41/02

(52) U.S. Cl. CPC B65D 81/3881; B65D 83/0038; A45F 2200/0583; A45C 11/20; A47J 41/022; A45F 3/02

(57) ABSTRACT

A thermally insulated cooler for keeping canned drinks cold has a tubular shape. Cans are stacked in the tube one atop the other, and the inner diameter of the tube fits closely around the circumference of the cans. The length of the cooler can be sized to accommodate various numbers of cans. The cooler is of double wall construction, and the space between the walls is either a vacuum or a thermally insulating material. A coil spring in the bottom of the tube biases the cans through the upper end of the tube. A retaining ring mounted to the open end of the tube has an opening with radially inwardly projecting tabs that grip a can as the spring feeds it through the opening. The tabs hold the can partially protruding from the tube until a user affirmatively removes the can from the tube.

### CROSS-REFERENCE TO RELATED APPLICATIONS

This application claims priority of International Application No. PCT/US 17/30699, filed May 2, 2017, which claims priority of U.S. Provisional Application No. 62/391,606, filed May 4, 2016, and U.S. Provisional Application No. 62/391,549, filed May 3, 2016.

### BACKGROUND OF THE INVENTION

### Technical Field

The present invention relates generally to coolers for keeping beverages cold, and more particularly to a portable, insulated cooler for keeping multiple canned drinks cold and for dispensing them one at a time.

### Background Art

Insulated portable coolers for keeping food and beverages cold are well known. These coolers typically take the form of an insulated box with a large, insulated lid that is openable or removable.

One of the most common uses for a cooler is to keep drink cans cold. The three most common standard sizes for beverage cans in the United States are 12 US fl oz (355 ml), 16 US fl oz (473 ml), and 8.4 US fl oz (250 ml). All three of these standard can sizes have a diameter of 2.60 inches (66.167 mm) at the widest point of the body and a diameter of 2.34 inches (59.44 mm) at the lid. The can sizes differ only in their heights: the 12 fl oz ca n is 4.81 inches (122.23 mm) tall, the 16 fl oz can is 6.19 inches (157.62 mm) tall, and the 8.4 fl oz can is 3.60 inches (91.50 mm) tall.

A box-shaped cooler does not offer the most efficient use of space for storing canned beverages. First, the cans are cylindrical, and even if the cans are organized efficiently, there remains a considerable amount of empty space between the cylindrical cans and the flat cooler walls. Cans are often placed in the cooler randomly, or if placed efficiently initially, will frequently shift as the cooler is moved. This haphazard arrangement can leave even more space around each can. Additionally, the cooler is usually not completely filled with cans, especially with coolers that have a large capacity.

Consequently, there can be considerable empty space left in the cooler when the drink cans are stored. This empty space results in less efficient insulation and in a cooler that is larger and bulkier than necessary.

In addition, because of the area of the lid, opening the cooler to access its contents allows considerable warm air to enter the cooler. If is desired to remove a single can on each of several occasions, the cooler must be opened multiple times. The volume of warm air entering the cooler each time it is opened will compromise the ability of the cooler to keep the contents chilled. If multiple drink cans are withdrawn at one time to minimize the number of times the lid is opened but are then consumed only one drink at a time, then the later-consumed drinks will not be as cold.

Insulating sleeves, often called “coozies,” are known for keeping individual canned drinks chilled. Some recently introduced coozies are double-wall, stainless-steel sleeves with a vacuum between the inner and outer walls. In some instances, the outer surface of the inner stainless steel wall is coated with copper to reflect radiant heat from the outer wall. These coozies will keep canned drinks chilled but accommodate only a single can.

Thus there is a need for an improved insulated container that will hold a plurality of canned beverages and keep them chilled until ready for consumption.

There is a need for a cooler that will more efficiently accommodate cylindrical cans without leaving large amounts of empty space.

There is a further need for a portable insulated cooler that will reduce the amount of warm air that enters the cooler when a single drink can is removed.

There is also a need for a cooler that will fit into spaces that will not accommodate a cooler that is box-shaped.

Other objects, features, and advantages of the disclosed embodiments will become apparent upon reading the specification in conjunction with the appended claims.

### BRIEF SUMMARY OF THE INVENTION

The present invention relates to a tubular-shaped cooler for keeping beverages in standard beverage cans at a temperature below the ambient temperature. An insulated tube has concentric inner and outer tubular walls disposed in parallel, spaced-apart relation. The insulated tube has a closed first end and an opening at its second end. The opening is selectively closable by a cap. The inner tubular wall defines a cylindrical chamber for receiving beverage cans.

The space between the inner and outer walls reduces conductive heat transfer between the ambient and the cylindrical chamber of the tube. The spaced-apart inner and outer walls define a sealed, generally annular cavity within which a vacuum exists. The vacuum reduces radiative heat transfer between the ambient and the cylindrical chamber of the tube.

The insulated tube has a length sufficient to hold a plurality of standard cans stacked therewithin in end-to-end relation. The cylindrical chamber of the tube has a diameter of between 0.02 inches (0.5 mm) and 0.35 inches (8.9 mm) greater than the diameter of a standard beverage can.

Optionally, a compression spring assembly is positioned in the closed end of the cylindrical chamber. When a stack of cans is loaded into the tubular cooler, the spring assembly exerts a force on the bottom of the stack and feeds the cans sequentially through the open second end.

Also optionally, a retaining ring is mounted to the open end of the tube. The retaining ring includes an opening through which a beverage can passes. Tabs extending inward of the opening bear against the side of the beverage can and holds the can, partially protruding from the top of the tube, until the user affirmatively removes it.

Thus, it is an object of the present invention to provide an improved cooler for keeping beverages in standard beverage cans at a temperature below the ambient temperature.

It is a further object of the invention to provide a tubular-shaped cooler configured to hold a plurality of beverage cans stacked one atop another.

It is still another object of the invention to provide a tubular-shaped cooler having concentric, spaced-apart inner and outer walls, with a vacuum in the space between the walls, to reduce conductive and convective heat transfer between the ambient and the chamber of the tubular cooler.

Other objects, features, and advantages will become apparent upon reading the following specification, in view of the appended drawings and claims.

### BRIEF DESCRIPTION OF THE SEVERAL VIEWS OF THE DRAWINGS

FIG. 1 is a side view of a tubular can cooler according to a first embodiment.

FIG. 2 is a vertical section view of the tubular can cooler of FIG. 1.

FIG. 3 is an enlarged partial view of the portion of FIG. 2 indicated by the dashed line 3.

FIGS. 4-7 show the operation of the tubular can cooler of FIG. 1 to withdraw a single can.

FIG. 8 is a cutaway version of a second embodiment of a tubular can cooler.

FIG. 9 is a cutaway view of a third embodiment of a tubular can cooler.

FIG. 10 is a vertical section view of a fourth embodiment of a tubular can cooler.

FIGS. 11-14 are vertical section views illustrating the operation of the tubular can cooler of FIG. 10.

FIGS. 15-17 are vertical section views of a fifth embodiment of a tubular can cooler.

FIG. 18 is a vertical section view of a sixth embodiment of a tubular can cooler.

FIG. 19 is an isometric view of a clip for coupling two tubular can coolers together.

FIG. 20 is an isometric view of two tubular can coolers affixed in parallel, side-by-side arrangement by two of the clips of FIG. 19.

FIG. 21 is a side view of a seventh embodiment of a tubular can cooler.

FIG. 22 is a partially exploded side view of the tubular can cooler of FIG. 21, showing a retaining ring assembled onto the upper end of the tube.

FIG. 23 is a vertical section view of the tubular can cooler of FIG. 20.

FIG. 24 is a side view of a compression spring assembly of the tubular can cooler of FIG. 20.

FIG. 25 is a vertical section view of the tubular can cooler of FIG. 20 containing a compressed spring assembly and a full complement of beverage cans.

FIG. 26 is a vertical section view of the tubular can cooler of FIG. 25 showing three beverage cans and a partially decompressed spring assembly.

FIG. 27 is a vertical section view of the tubular can cooler of FIG. 25 showing one beverage can and a spring assembly decompressed to the full extent permitted by a constraining cable.

FIG. 28 is a top view of the retaining ring of the tubular can cooler of FIG. 20.

FIG. 29 is an enlarged, partial view of the section of the retaining ring enclosed by the dashed line 29 in FIG. 28.

FIG. 30 is a top view of the retaining ring of FIG. 28 with a beverage can located within the retaining ring.

FIG. 31 is a side view of the upper portion of the tubular can cooler of FIG. 20 with the cap shown in section.

FIG. 32 is a side view of the upper portion of the tubular can cooler of FIG. 31 with the cap removed.

### DETAILED DESCRIPTION OF THE INVENTION

Referring now to the drawings, in which like numerals indicate like elements throughout the several views, FIG. 1 shows an insulated cooler 100 for holding beverage cans. The cooler comprises an elongated tube 102 having an upper end 104 and a lower end 106. The upper end 104 of the tube 102 has a circular opening 108 defined by an annular collar 110. The collar 110 is externally threaded for engaging a cap 112. The lower end 106 of the tube 102 is closed.

Circumferential bands 114, one on the upper portion of the tube and another on the lower portion, provide attachment points for a carrying strap 116. The bands 114 can be comprised of an elastic material or can be annular clamps that attach to the circumference of the tube 102.

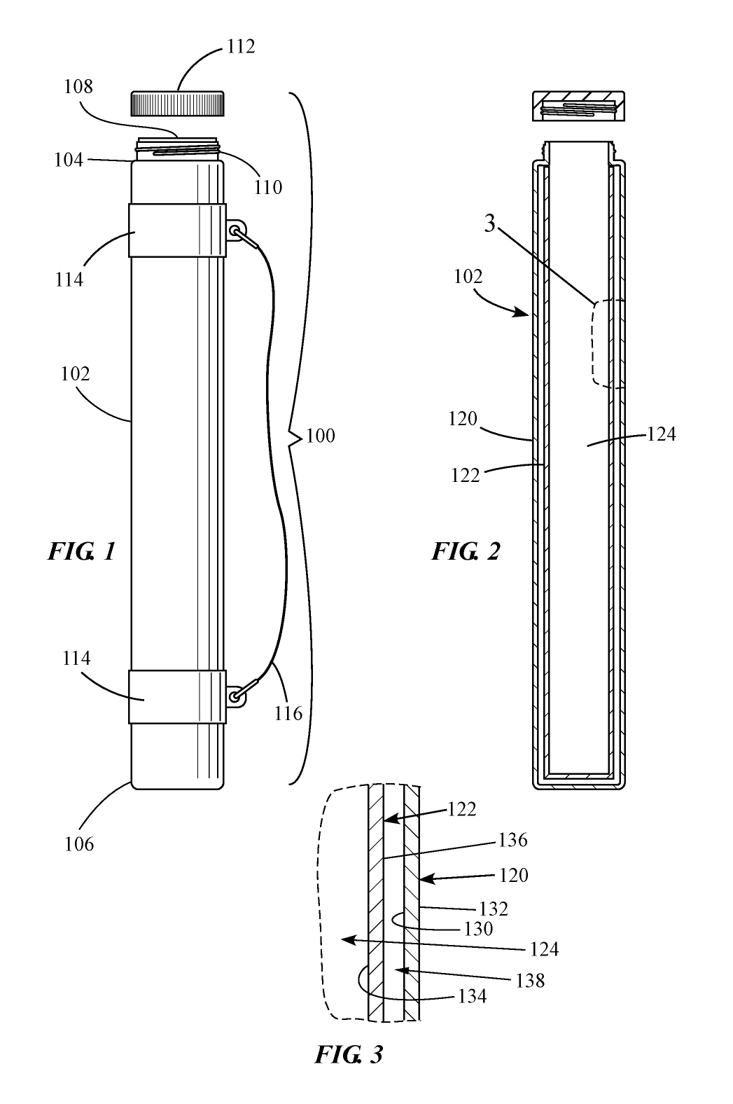

Referring now to FIG. 2, the tube 102 comprises outer and inner tubular walls 120, 122 in parallel, spaced apart relation. The inner tubular wall 122 defines a cylindrical chamber 124 that extends through the opening 108 in the annular collar 110. In the disclosed embodiment, the walls 120, 122 are fabricated from 8/18 kitchen grade stainless steel, but it will be understood that other rigid materials including, but not limited to, aluminum, carbon fiber or graphite reinforced polymers, and synthetic resins can also be employed.

The wall construction of the tube 102 is shown in more detail in FIG. 3. The outer wall 120 has an inner surface 130 and an outer surface 132. The inner wall 122 has an outer surface 134 and an inner surface 136. The sealed space 138 between the inner surface 130 of the outer wall 120 and the outer surface 134 of the inner wall 122 is a partial vacuum.

Optionally, the outer surface 134 of the inner wall 122 can be made reflective to minimize heat transfer from the outer wall 120 to the inner wall 122 by radiation. The reflective surface can be achieved by coating the outer surface 134 of the inner wall 122 with a thin layer of copper, silver, or other highly reflective coating, or by highly polishing the stainless steel outer surface of the inner wall.

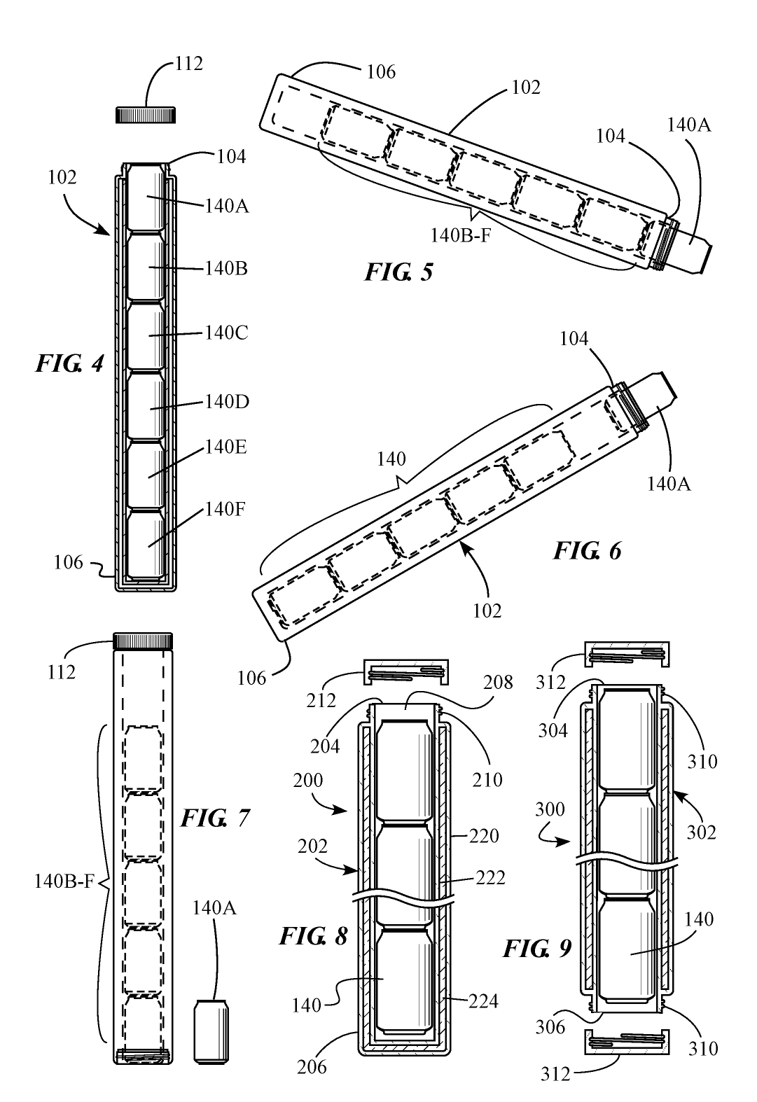

Referring to FIG. 4, the chamber 124 of the tube 102 is long enough to accommodate six 12 fl oz drink cans 140A-F stacked one atop another. (As used herein, reference to a can or cans generally will be identified by the numeral 140, and reference to a particular can will be identified by the numeral 140 followed by a letter, e.g., 140A.) The 12 fl oz cans are each 4.81 inches (122.23 mm) tall, and so a stack of six cans is just under 29 inches (735 mm) tall. Adding space for the double wall construction above and beneath the stack of cans and the height of the annular collar, the overall length of the cooler 100 is approximately 31 inches (787 mm).

While the cooler 100 is dimensioned to store six 12 fl oz cans, it will be understood that, for this and all other embodiments disclosed herein, the length of the tube 102 can be such as will receive a greater or lesser number of cans 140.

In a disclosed embodiment the inner diameter of the inner wall 122 is about 2.68 inches (68 mm), and the inner wall is approximately 0.06 inches (1.3 mm) thick. The outer diameter of the outer wall is about 3.54 inches (90 mm), and the outer wall is approximately 0.06 inches (1.5 mm) thick. The space between the walls is about 0.31 inches (8 mm). These dimensions are for example only. Actual thicknesses of inner and outer walls may be greater to increase structural integrity for longer coolers, or may be reduced for shorter coolers where structural strength is less critical.

The inner diameter of the cylindrical chamber 124 is dimensioned to closely fit a drink can 140. As indicated above, the diameter of standard cans in the United States for packaging beer, soft drinks, and the like is 2.60 inches (66.167 mm) in diameter. The diameter of the chamber 124 is small enough to fit snugly around a can 140 to prevent unnecessary air gaps between the inner surface 138 of the inner wall 122 and the cans 140, and yet large enough that the cans 140 can slide easily into and out of the tube 102 without undue friction or interference. In a disclosed embodiment, the inner diameter of the tube chamber is advantageously between 2.62 inches (66.55 mm) and 2.95 inches (75 mm), more preferably between 2.62 inches (66.55 mm) and 2.76 inches (70 mm), and even more preferably between 2.63 inches (66.85 mm) and 2.68 inches (68 mm).

The foregoing dimensions for the inner diameter of the tube chamber presuppose a cooler for accommodating U.S. standard can sizes. These measurements can be adapted to standard can sizes of other countries by adding to the diameter of the can between 0.02 inches (0.5 mm) and 0.35 inches (8.9 mm), more preferably between 0.02 inches (0.5 mm) and 0.16 inches (4.0 mm), and even more preferably between 0.0267 inches (0.68 mm) and 0.08 inches (2 mm).

FIGS. 4-7 depict the operation of the tubular insulated cooler 100 to withdraw a single can 140. In FIG. 4, the tube 102 is held with the upper end 104 higher than the lower end 106, so that the cap 112 can be removed without the cans 140 sliding out of the tube. In FIG. 5, the tube 102 is tilted so that the upper end 104 is slightly below the lower end 106, enabling the cans 140 to slide gently toward the opening 108 in the upper end of the tube, until a portion of the first can 140A has emerged from the tube. In FIG. 6, the user holds on to the exposed portion of the emerging can 140A while tilting the tube 102 until the bottom end 106 is once again lower than the upper end 104, causing the other cans 140B-F to slide back to the bottom of the tube. In FIG. 7, the top can 140A has been removed from the tube 102 and the top 112 replaced.

Repeating this procedure enables the remaining cans 140B-F to be withdrawn sequentially one at a time, with the topmost can in the stack being removed each time.

By constraining the opening 108 to a diameter only large enough to permit the cans 140 to slide out, very little warm ambient air enters the cooler 100 as a can is withdrawn. This is in contrast to the much larger amount of ambient air that enters through the large, rectangular lid of a conventional box-shaped cooler.

FIG. 8 shows a second embodiment 200 of a double-walled, insulated tubular cooler. The cooler 200 comprises a tube 202 in the shape of an elongated tube having an upper end 204 and a lower end 206. The upper end 204 of the tube 202 has an opening 208 defined by an annular collar 210. The collar 210 is externally threaded for engaging a cap 212. The lower end 206 of the tube 202 is closed.

The cooler 200 has rigid double walls 220, 222 in parallel, spaced-apart relation with an insulating material 224 filling the space between the walls. The rigid walls 220, 222 of the tube 202 are molded from polyethylene, and the insulating material 224 filling the space between the walls is blown polyurethane. In the disclosed embodiment, the polypropylene has a thermal resistance of about R 2.5, and the polyurethane has a thermal resistance of about R 9. A suitable polyurethane is sold as of the filing date of this application by the Eastman Chemical Company under the trademark Triton®.

FIG. 9 illustrates another embodiment 300 of a tubular cooler. The cooler 300 is similar to the cooler 200 described above, with the exception that both the upper and lower ends 304, 306 of the tube 302 have a threaded collar 310 for engaging a cap 312. This arrangement allows drink cans 140 to be accessed from either end of the tube 302.

As previously indicated, the tubular coolers described in this application are not limited to tubes holding six cans 140. Rather, the length of the tube can be dimensioned to accommodate a greater or lesser number of cans. For ease of description, the following embodiments will be disclosed with respect to tubes having a capacity of three cans 140A-C.

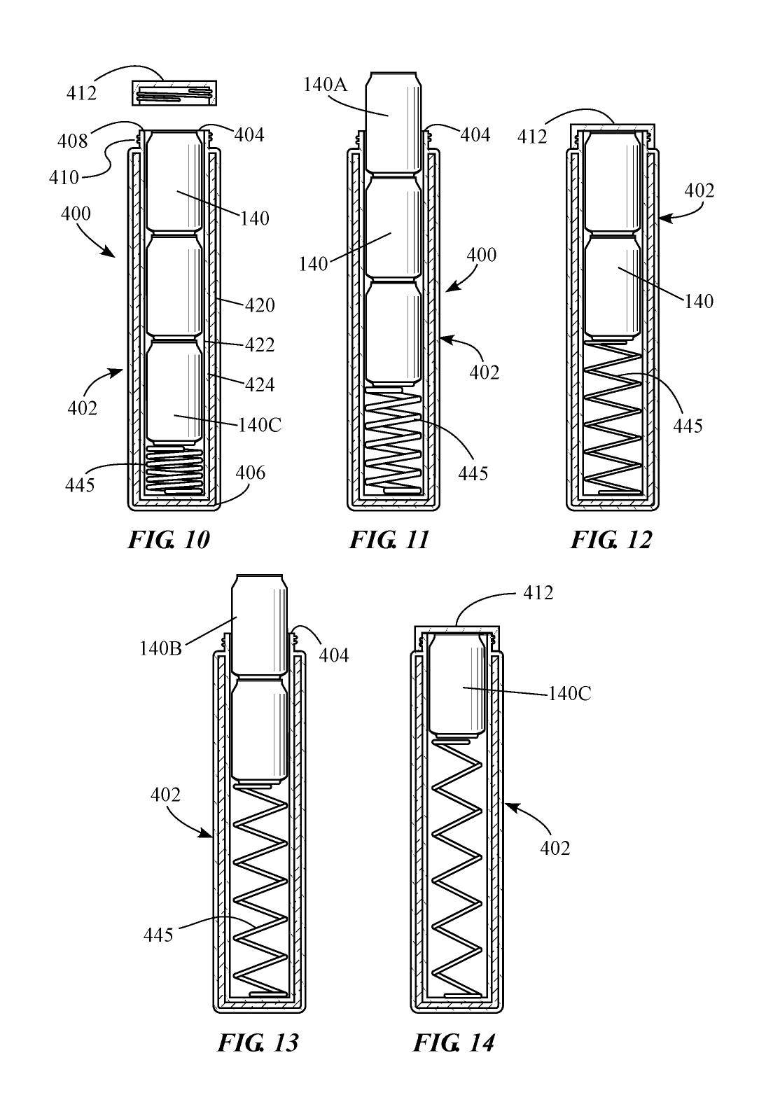

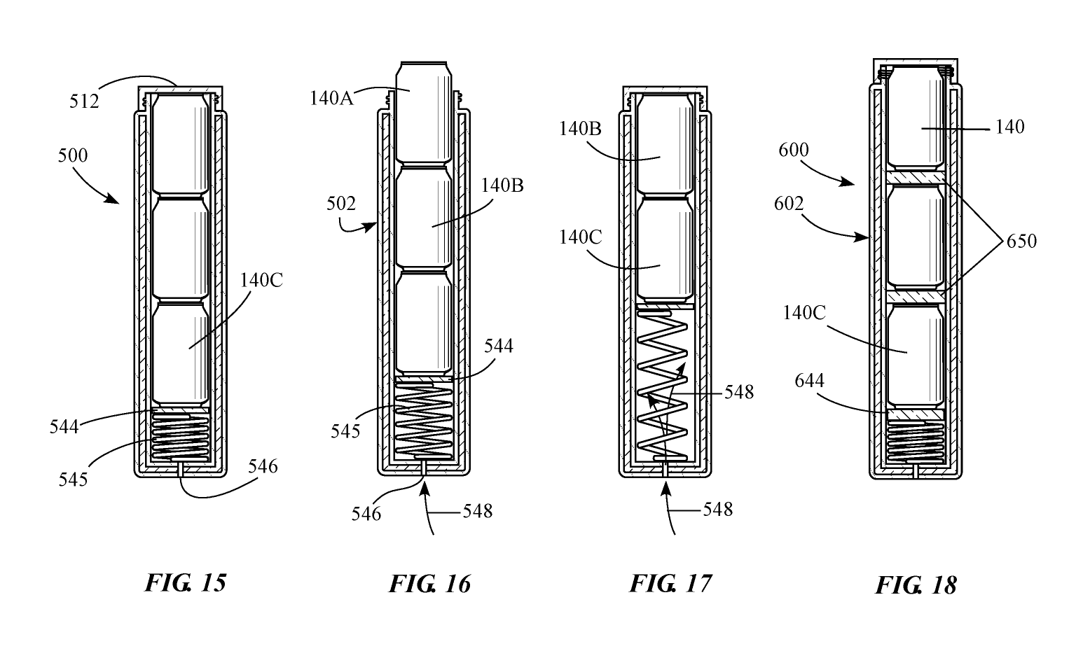

FIG. 15 illustrates a tubular can cooler 500 that is nearly identical to the cooler of FIG. 10. The primary difference is that the cooler 500 has a disk 544 interposed between the upper end of the compression spring 545 and the bottommost can 140C. Advantageously, the disk 544 can be made of a thermally insulating material. The disk 544 has a diameter closely corresponding to the diameter of a can 140 at its broadest point, i.e., 2.34 inches (59.44 mm). The disk 544 acts as a piston. In addition, a vent 546 is formed in a lower portion of the tube 502, in this case, the lower end 506 of the tube.

Referring to FIGS. 16 and 17, when the cap 512 is removed from the tube 502, the spring 545 pushes the disk 544 upward, ejecting the topmost can 140A. As the disk 544 moves upward, warm ambient air, indicated by the arrows 548, is drawn in through the vent 546 in the lower end 506 of the tube 502. The ambient air is largely prevented by the disk 544 from entering the portion of the chamber where the cans 140 reside, thus enhancing the insulating capacity of the cooler 500.

FIG. 18 shows another embodiment 600 of a tubular can cooler. This cooler 600 is very similar to the cooler 400 of FIG. 10, except that in between cans 140 are placed one or more rigid disks 650 filled with refrigerant gel. An example of a suitable refrigerant gel is a polypropylene gel sold as of the filing date of this application by Newell Rubbermaid Inc. under the trademark Blue Ice®. The disk 644 between the compression spring 640 and the bottom drink can 140C may also be filled with refrigerant gel. Before use, the refrigerant disks 650 are chilled in a freezer. Then when the tube 602 is loaded, the refrigerant disks 650 are interspersed among the cans 140. The refrigerant disks 650 keep the canned beverages cold longer than an identical tube with no refrigerant disks.

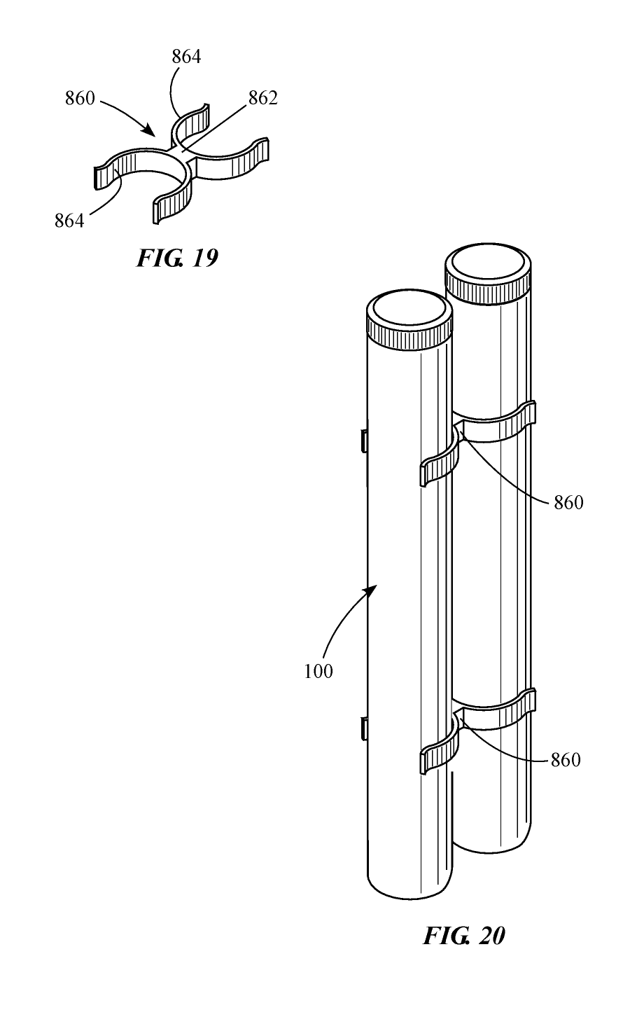

FIGS. 19 and 20 show retainer flaps 752 that can be used with any of the tubular coolers described above. The retainer flaps 752 are formed of rubber or synthetic rubber and extend partially across the opening at the upper end of the cylindrical chamber 724 in which the cans reside. As a can 140 is ejected from the tube, the retainer flaps 752 exert interference and frictional forces to slow the can and help prevent it from becoming fully separated from the tube until the user grasps the exposed portion of the can and affirmatively pulls the can from the tube.

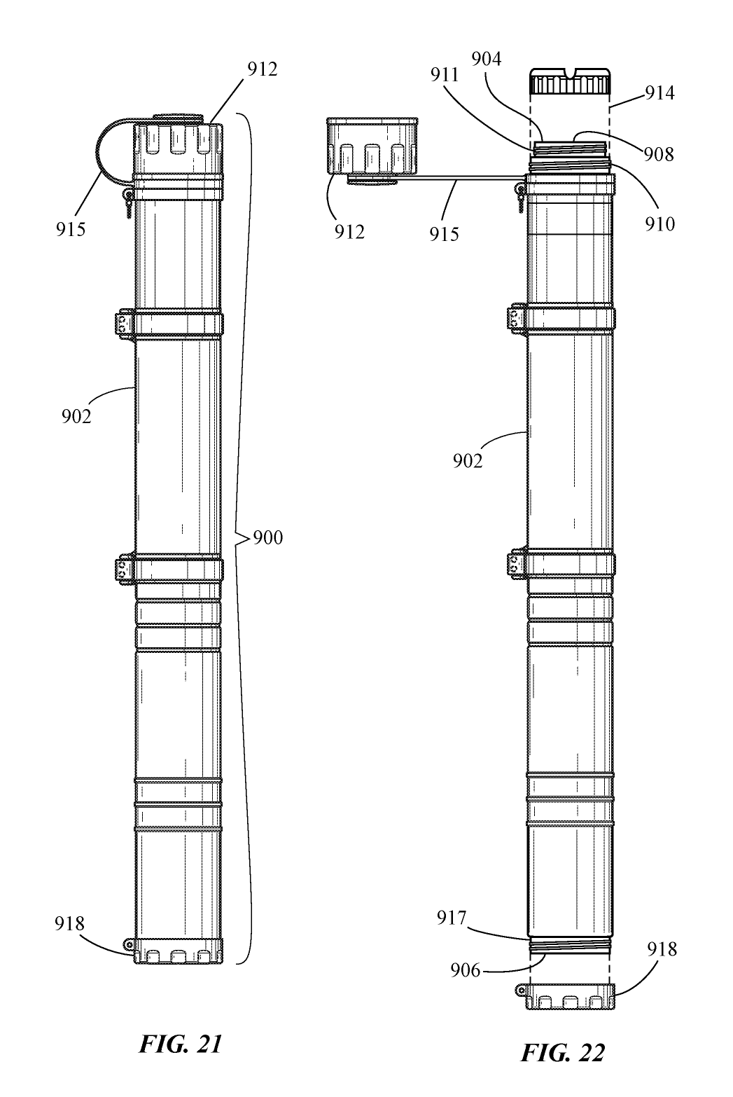

FIG. 21 illustrates a clip 860 for holding two tubular coolers, e.g., coolers 100, in parallel, side-by-side relation. The clip 860 has a central portion 862 and two sets of deformable, resilient arms 864 dimensioned to snap onto a tubular tube. As can be seen in FIG. 22, two clips 860 snap onto two tubes 102, one clip 860 located on an upper portion 104 of the tubes and the other clip 860 on a lower portion 106. The clips 860 make it easy and convenient to carry multiple tubular coolers 100 at one time.

While the clips 860 have been disclosed in conjunction with two coolers 100, it will be understood that the clips can be used with any of the embodiments of tubular coolers disclosed herein.

Each of the tubular can cooler embodiments disclosed herein has a cap, typically plastic, that closes the upper end of the tube. While the tubular coolers have been disclosed with respect to an internally threaded cap that screws onto an externally threaded neck on the tube, other cap configurations are contemplated. For example, a cap can attach by friction fit to a smooth neck on the tube, a cap can snap on, or a cap can be hinged to the tube and be held in closed position by a latch. The friction fit cap, the snap-on cap, and the threaded cap can be secured to the tube by a flexible connector, such as a strap or cord, to prevent the cap from becoming separated from the tube when removed.

Some of the embodiments of tubular can coolers have been disclosed with respect to stainless steel, double wall, vacuum insulated construction, while others have been disclosed with respect to double walls of polypropylene, with foamed polyurethane filling the spaces between the walls. It will be understood, however, that for purposes of this disclosure, any embodiment of a tubular can cooler illustrated with a composite wall structure can also be manufactured using a stainless steel, double wall, vacuum insulated construction, and vice versa.

In addition, if difficulty is encountered with the strap bands not remaining fixed in place under the stress of the forces exerted on the strap, a shallow circumferential recess can be formed on the outer wall of the tube to prevent the strap bands from sliding on the tube.

FIGS. 21 and 22 show another embodiment 900 of a tubular cooler for holding standard beverage cans 140. The cooler 900 comprises an elongated tube 902 having an upper end 904 and a lower end 906. The upper end 904 of the tube 902 has a first annular collar 908 and a second, coaxial, annular collar 910 of smaller diameter than the first collar 908. The first collar 908 is externally threaded for engaging a cap 912. The second collar 910 is externally threaded for engaging a retaining ring 914. When detached from the first collar 910, the cap 912 is tethered to the tube 902 by a strap 916.

At the lower end 906 of the tube 902 is a bottom annular collar 917. The bottom annular collar 917 is externally threaded for engaging a cap 918. The cap 918 remains fixed to the bottom annular collar 917 during normal operation and closes the lower end 906 of the tube 902.

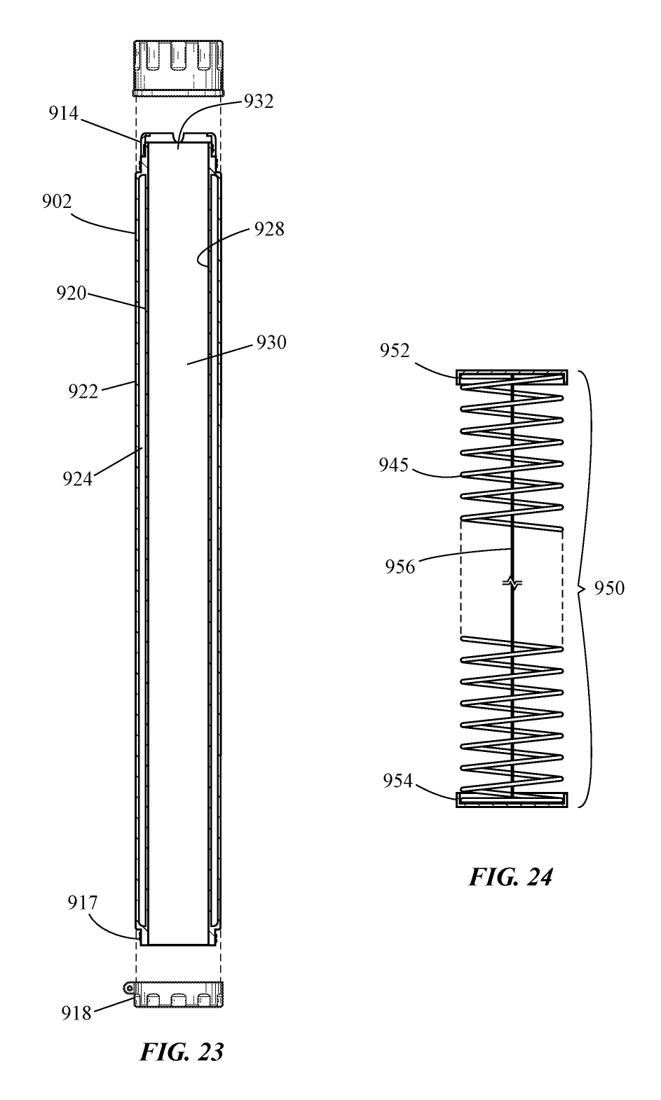

Reference is now made to FIG. 23. The tube 902 is manufactured from stainless steel or other suitable material. The tube 902 has a rigid cylindrical inner wall 920 and a rigid cylindrical outer wall 922 in parallel, spaced-apart relation to the inner wall. A space 924 is formed between the inner and outer walls 920, 922. A partial vacuum exists in the space 924 between the inner and outer walls 920, 922. The spaced apart relation of the walls 920, 922 reduces heat transfer by conduction between the inside and the outside of the tube 902. The vacuum in the space 924 between the inner and outer walls 920, 922 reduces heat transfer by convection between the inside and the outside of the tube 902.

The interior surface 928 of the inner wall 920 defines a cylindrical chamber 930 extending the entire length of the tube 902. The cylindrical chamber 930 has an opening 932 at its upper end through which beverage cans are loaded into the cooler 900, as will be explained below. The inner surfaces of the first and second annular collars 908, 910 have the same interior diameter as the inner wall 920 of the tube 902, such that the cylindrical chamber 930 is smooth and uninterrupted.

With reference now to FIG. 24, the cooler 900 includes a compression spring assembly 950. The spring assembly 950 comprises a spring 945, an upper cap 952, a lower cap 954, and a constraining cable 956. The constraining cable is located within the coils of the spring 945. The upper end of the constraining cable 956 is attached to the upper cap 952, and the lower end of the cable is attached to the lower cap 954.

For a six-can tubular cooler, the constraining cable 956 is approximately the length of five cans 140, or about 24 inches (610 mm). Thus when the last can 140 is fed from the upper end of the tube 902, the spring assembly 950 is constrained from decompressing any further, preventing the upper end of the spring from extending above the upper end of the tube 902.

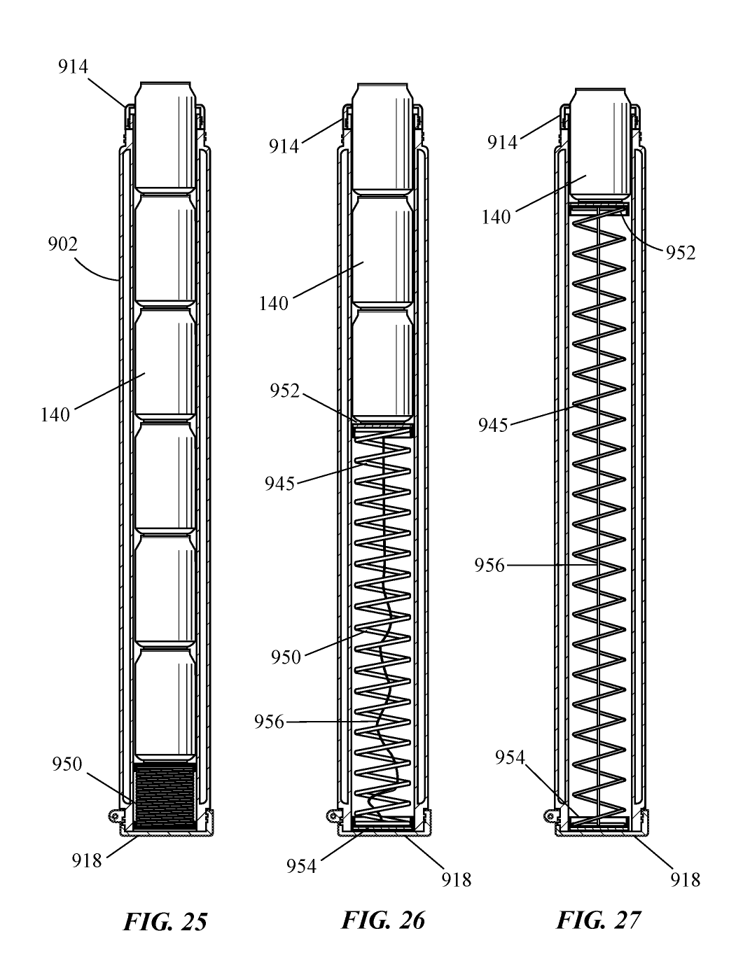

Referring to FIGS. 25-27, the tube 902 is designed to receive a plurality of cans 140 stacked atop one another. The disclosed embodiment 900 is dimensioned to hold a maximum of six cans, but the length of the tube 902 can be selected to hold a greater or lesser number of cans. The spring assembly 950 is located within the lower end of the tube. The lower cap 954 of the spring assembly 950 rests against the cap 918 at the lower end of the tube 902, and the upper cap 952 of the spring assembly bears against the lower end of the bottom can 140. The spring assembly 950 feeds the stack of cans 140 upward through the opening 932 in the upper end 904 of the tube 902.

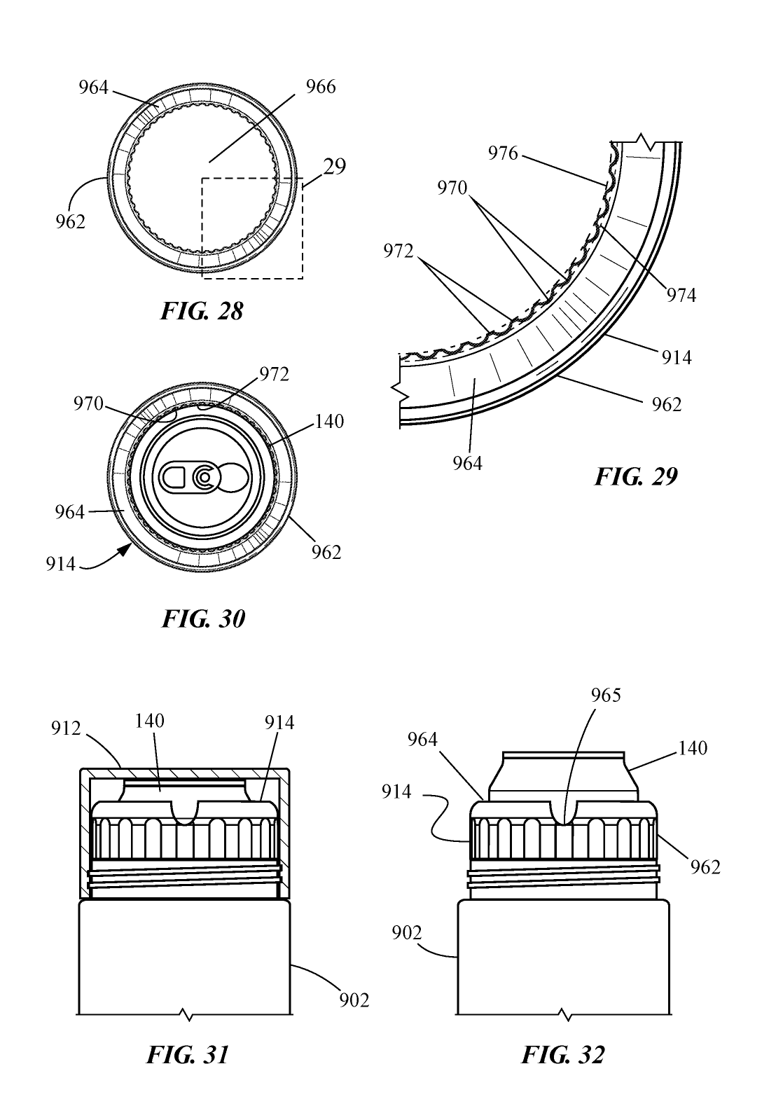

If the cans 140 were allowed to slide freely in and out of the tube 902, two adverse consequences might occur. First, if the tube 902 were accidentally inverted, all of the cans would slide out. And second, the spring assembly 950 could launch the cans out of the opening 932 at the upper end of the tube one after another until all the cans were discharged. To address these issues, the retaining ring 914 is provided, as will be explained with reference to FIGS. 28-32. The purpose of the retaining ring 914 is to grip the sides of a can 140 and to hold the can partially protruding from the upper end of the tube 902 until the user affirmatively pulls the can from the tube.

The retaining ring 914 mounts to the upper end of the tube 902. The retaining ring 914 has a cylindrical side wall 962 and an upper surface 964. The inward facing surface of the side wall 962 is threaded to engage a cooperating thread at the upper end of the tube 902 to mount the ring to the tube. Recesses 965 extend downward from the upper edge of the side wall 962 on opposite sides of the ring 914. The user can grasp the edges of a can 140 through the finger-receiving recesses 965 to facilitate withdrawing a can from the tube.

As can perhaps best be seen in FIG. 28, a generally circular opening 966 is formed in the upper surface 964 of the retaining ring 960. With reference to FIG. 29, the edge of the circular opening 966 comprises a plurality of alternating recesses 970 and flexible, resilient tabs 972. By way of example only, the retaining ring 960 of the disclosed embodiment comprises 50 alternating tabs 972 and 50 intervening valleys 970. A first, outer diameter 974 is defined by the bases of the recesses 970, and a second, inner diameter 976 is defined by the peaks of the tabs 972. In the disclosed embodiment the edges of the tabs 972 constitute approximately 30% of the inner diameter 976, with the remaining 70% of the inner diameter being interrupted by the recesses 970.

In the disclosed embodiment, the outer diameter 974 of the opening defined by the valleys of the recesses 970 is 2.65 inches (67.4 mm). The inner diameter 976 defined by the peaks of the tabs 972 is 2.58 inches (65.5 mm). By comparison, the diameter of the body of a 12 US fl oz drink can 140 is (2.60 inches, or 66.167 mm). Thus the maximum diameter of the body of a drink can 140 is less than the outer diameter 974 of the opening but less than the inner diameter 976 of the opening.

Because the outer diameter 974 of the opening 966 is greater than the diameter of a drink can 140, a drink can is able to fit through the opening 966. However, the flexible, resilient tabs 972 define a diameter that is 0.02 inches (0.667 mm) less than the diameter of the can. Thus when a can 140 is inserted into the opening 966, the tabs 972 flex to conform to the body of the can. Alternatively, rather than the tabs 972 flexing, the body of the can 140 might flex inwardly in response to the radially inward force exerted by the tabs. Either way, the tabs 970 exert a radially inward force against the body of the drink can 140.

The flexibility and resilience of the material comprising the tabs 972, the area of contact between the tabs and the body of the can 140, and the height of the tabs are selected to restrain a can inserted into the retaining ring 970 and to feed cans one at a time from the upper end of the tube 902. More specifically, the amount of force needed to advance a can through the retaining ring can be determined as follows. To prevent a column of six cans from falling out of the tube 902 when the tube is inverted, the retaining ring must be able to withstand the weight of the column of cans. A single 12 fl oz can of a soft drink weighs 13.5 ounces (12 fl oz refers to a volume, not a weight; 12 fl oz of water weighs 12 oz, but other liquids may be more or less dense than water). The weight of a six-can stack is thus 81 oz, or approximately 5 lbs (2.27 kg). Thus, to prevent the weight of the cans alone from causing the cans to fall out of the tube when the tube is inverted, the retaining ring must be able to resist a force of at least about five pounds (2.27 kg).

Operation of the cooler 900 will be explained with reference again to FIGS. 25-27. With a full complement of cans 140 stacked in the tube 902, the spring assembly 950 in the base of the tube is almost fully compressed. The cap 912 (see, for example, FIG. 20) is removed from the upper end 904 of the tube. With upward movement of the stack of cans 140 no longer constrained by the cap 912, the compression spring assembly 950 forces the stack of cans 140 upward. The top can 140 is pushed through the opening 932 at the upper end 904 of the tube 902. The retaining ring 914 grips the sides of the top can 140 and holds it partially protruding from the upper end of the tube 902. The user grasps the protruding portion of the top can 140, facilitated by the finger receiving recesses 965, and pulls the can from the tube 902. The cap 912 is then replaced to prevent further discharge of cans 140 from the tube 902.

In FIG. 26 the spring 945 has pushed the stack of cans 140 upward, causing a subsequent can 140 to emerge through the opening 908 at the upper end of the tube. As cans 140 are sequentially discharged from the upper end 904 of the tube 902, the spring assembly 950 decompresses. So long as cans remain in the tube, the constraining cable 956 of the spring assembly 950 is slack, as shown in FIG. 26. The retaining ring 914 grips the emerging can 140 and holds it until the user affirmatively removes it. The user then grasps the can 140, once again with the assistance of the finger receiving recesses 965, and pulls it the rest of the way out of the tube 902. The cap 912 is once again replaced atop the tube 902, as shown, e.g., in FIG. 22.

In FIG. 27 the last can 140 is pushed into discharge position by the decompression of the spring assembly 950. The constraining cable 956 becomes taut, preventing any further decompression of the spring assembly 950. The retaining ring 914 grips the emerging can 140 and holds it until the user affirmatively removes it.

A compression spring by its nature exerts less force as the spring decompresses. That characteristic works well with the cooler 900, because the spring 945 decompresses only as a can 140 is removed. Thus as the spring 945 ejects the first can 140, the spring assembly 950 will exert less upward force because of the decompression of the spring. But because the first can 140 is no longer in the stack, the column of cans is lighter than previously, and less spring force is needed to lift the remaining five cans. As the spring assembly 950 ejects the second can 140, the spring will exert less force because of the decompression of the spring. But because the first and second cans 140 have been ejected, the column of cans is even lighter, and less spring force is needed to lift the remaining four cans.

Selecting a compression spring requires balancing a number of factors that affect the force of the spring. Those factors include, but are not limited to: the material from which the spring is constructed; the thickness of the wire; the cross-sectional shape of the wire; the length of the spring wire; and the number of coils. In the disclosed embodiment, for a spring in a tube having a three-can capacity, a suitable spring includes a stainless steel wire 1500 mm in length, 56 mm in diameter, and round cross section, formed into nine coils.

The spring assembly 950 is ideally one that will both lift a stack of six cans 140 when compressed and still exert enough force as it reaches a fully decompressed state—or in the alternative, as it reaches a constrained state less than fully decompressed—to lift a single can. Further, it is undesirable for the upper end of the spring assembly 950 to extend above the upper end of the tube 902 when the spring is fully decompressed.

The constraining cable 956 permits the use of a spring assembly 950 that is not fully decompressed upon ejection of the last can 140. Because the spring 945 has not fully decompressed, the constraining cable 956 insures that the spring can still have enough force to lift the last can 140 to the upper end of the tube 902. Also, because the spring 945 does not reach its state of full decompression, the spring can exert more force than if it were fully decompressed.

Because the three most common standard sizes for beverage cans in the United States—12 US fl oz (355 ml), 16 US fl oz (473 ml), and 8.4 US fl oz (250 ml)—all have a diameter of 2.60 inches (66.167 mm) at the widest point of the body, 12 fl oz, 16 fl oz, and 8.4 fl oz cans can all be accommodated by the coolers described above. The can sizes differ only in their heights: the 12 fl oz can is 4.812 inches (122.225 mm) tall, the 16 fl oz can is 6.19 inches (157.62 mm) tall, and the 8.4 fl oz can is 3.602 inches (91.491 mm) tall. Consequently, a tube for accommodating six 12 fl oz cans (28.8 inches tall) will also accommodate four 16 fl oz cans or eight 8.4 fl oz cans.

Finally, it will be understood that the foregoing embodiments have been disclosed by way of example, and that other modifications may occur to those skilled in the art without departing from the scope and spirit of the appended claims.

1. (canceled)

2. The apparatus of claim 14, wherein said inner and outer tubular walls are stainless steel.

3. The apparatus of claim 14, wherein said annular cavity between said inner and outer tubular walls is partially evacuated of air.

4. The apparatus of claim 14, wherein said cylindrical chamber of said insulated tube has a diameter of between 0.02 inches (0.5 mm) and 0.16 inches (4.0 mm) 0.35 inches (8.9 mm) greater than the diameter of a standard can disposed within said cylindrical chamber.

5. The apparatus of claim 14, wherein said cylindrical chamber of said insulated tube has a diameter of between 0.02 inches (0.5 mm) and 0.16 inches (4.0 mm) greater than the diameter of a can disposed within said cylindrical chamber.

6-8. (canceled)

9. The apparatus of claim 14, further comprising a coil spring disposed within said cylindrical chamber of said insulated tube, said coil spring having an upper end and having a lower end supported by said closed first end of said tube,
said spring being operative when a plurality of said beverage cans is loaded into said insulated tube to bias said plurality of cans toward said open second end of said insulated tube.

10. The apparatus of claim 9, further comprising a constraining cable linking said upper and lower ends of said coil spring, said length of said constraining cable preventing said spring from extending beyond a predetermined length.

11. (canceled)

12. The apparatus of claim 14, wherein said retaining ring holds a can against a force of at least five pounds.

13. The apparatus of claim 14, further comprising a cap selectively operable to close said opening at said second end of said insulated tube.

14. An apparatus for keeping beverages in beverage cans at a temperature below the ambient temperature, each of said beverage cans having a cylindrical side wall defining a diameter of said can, and a shoulder tapering upward and inward from an upper end of said cylindrical side wall, said apparatus comprising:
an insulated tube, said insulated tube having an inner tubular wall and a concentric outer tubular wall in parallel, spaced-apart relation, said inner and outer tubular walls defining a sealed, generally annular cavity therebetween;
said inner tubular wall defining a cylindrical chamber of said insulated tube;
said insulated tube having a closed first end and a second end;
said insulated tube defining an opening at said second end coaxial with said cylindrical chamber;
said insulated tube having a length sufficient to hold a plurality of beverage cans therewithin stacked in end-to-end relation;
a retaining ring located at the second end of said insulated tube, said retaining ring defining a circular opening coaxial with said cylindrical chamber, said circular opening having an edge; and
a plurality of radially inwardly extending tabs located on said edge of said circular opening for engaging the side wall of a can disposed within said retaining ring for holding said can until said can is acted upon by an outside force.

15. The apparatus of claim 14, wherein said tabs are deformable and resilient;
wherein when a can is disposed within said retaining ring, said plurality of tabs is deformed radially outwardly by the cylindrical side wall of said can; and
wherein said outwardly deformed tabs exert a radially inward force on the cylindrical side wall of said can, said radially inward force holding said can until said can is acted upon by an outside force.
